(19) United States
(12) Patent Application Publication
(10) Pub. No.: US 2008/0317539 A1
(43) Pub. Date: Dec. 25, 2008

(54) Applicator for Two or More Components

(76) Inventor: Gerhard Brugger, Pflach (AT)

Correspondence Address: KNOBBE MARTENS OLSON & BEAR LLP, 2040 MAIN STREET, FOURTEENTH FLOOR, IRVINE, CA, 92614, US

(21) Appl. No.: 11/912,285

(22) PCT Filed: Apr. 5, 2006
(86) PCT No.: PCT/EP2006/003105

§ 371 Date: Jun. 27, 2008

(30) Foreign Application Priority Data
Apr. 22, 2005 (DE) 20 2005 006 547

(51) Int. Cl. B05C 17/005

(52) U.S. Cl. 401/44; 401/151

(57) ABSTRACT

In order to provide an applicator for two or more components, in particular for an adjustable metering dispenser in which the components (A, B) are only mixed at an applicator surface (2) with outlet apertures (3), the outlet apertures (3; 3a, 3b) for one of the components (A) and for the other component (B) extend separately up to the applicator surface (2) and are brought together to a point at the applicator surface (2).

The invention is related to an applicator for two or more components, in particular for an adjustable metering dispenser, in accordance with the pre-characterizing features of claim 1.

Such applicators are used for adhesives or cosmetic products, e.g. lipsticks, having admixed thereto a care component. For this, static mixers have mostly been used so far, wherein the components are inserted into a helical tube and are mixed thereby. In doing so, it is, however, disadvantageous that a substantial remainder volume remains in the mixer, such that, for example, several strokes on the metering dispenser are necessary when the dosing relation is changed, in order to then finally obtain the desired mixing proportion. Since such components may be very expensive, it is desirable that this disadvantage be avoided to a large extent. Besides, the mixture in the static mixer may harden or become inactive, so that the latter must be exchanged or the mixture of the components will not be useful any more.

Therefore, it is the object of the invention to provide an applicator for two or more components, avoiding the above-mentioned disadvantages, in particular effecting a mixture of the components only at the application spot.

This object is achieved by an applicator having the characteristics of claim 1. Advantageous embodiments are the subject-matter of the subclaims.

Due to the multiplicity of outlet apertures which are separated for the two (or more) components up to the applicator surface and selectively brought together to a point only there, in particular in the form of a respective central nozzle surrounded by an annular gap, a mixture is only obtained at the surface. By this complete separation of the components up to the exit point, there remains none or only an extremely small remainder volume of mixed components. Besides, a homogeneous mixture is achieved by the annular casing of the one component with the other component, since the mixing effect is further improved by over-coating the surface when applying an adhesive or lipstick, in case of failing a sufficient mixture by its discharge at the ring nozzles.

The structure of the applicator allows the two components to be contained accurately separate, i.e. practically in two or more levels, so that the desired mixture will not escape before the exit point. This is required with some components, for example with adhesives, in order to avoid a premature hardening here. The allocation of the leaving component flows is being improved, if the one nozzle is fixed in the other outlet aperture by centering webs, so that the desired annular casing of the one component is guaranteed by the other component. Preferentially, the exhaust nozzles are formed in a conical shape here, whereby also the manufacturing cost of the multiplicity of nozzles can be reduced. Thus, “pin-pointed” mandrels can be used to form the nozzles in the die-casting tool. However, a substantially cylindrical design of the nozzles is also possible. Further, an economic manufacture of the applicator which is preferentially put on an adjustable metering dispenser is possible by splitting it into two levels or floors penetrated only by a supply channel for the one component to the “upper” floor.

An exemplified embodiment of the applicator will be described and explained in more detail hereinafter on the basis of the drawings, in which:

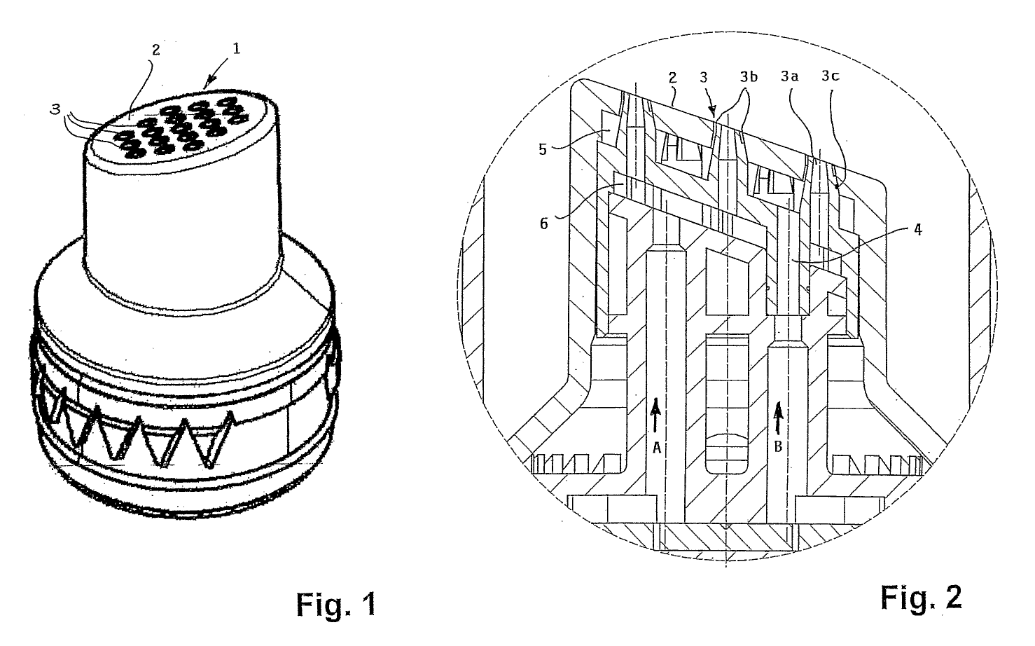

FIG. 1 is a perspective view of the applicator;

FIG. 2 is a cross-sectional view of the applicator; and

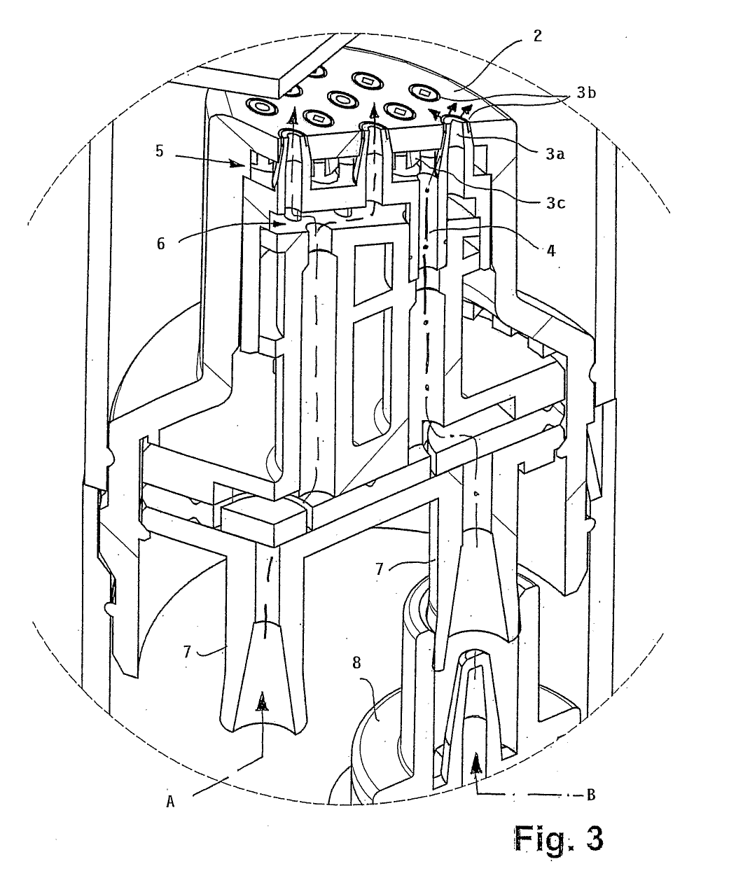

FIG. 3 is a partial view partially depicting the applicator surface.

FIG. 1 is a perspective view of an applicator 1. The latter exhibits an applicator surface 2 which is here illustrated as an inclined plane to facilitate the application of the mixed adhesive when used for a two-component adhesive or the like. The same applies for example to lipsticks or similar cosmetic products consisting of two or more components. These components are supplied or pumped, respectively, to the applicator surface 2 by a metering dispenser not shown in more detail, having cartridges 8, the two components (A and B) being separately supplied in tiers (cf. FIGS. 2 and 3). For this, the applicator surface 2 is provided with a multiplicity of outlet apertures 3, the one component A here, for example, leaving in the center (nozzle 3a), while component B leaves in floor 5, here the upper one, at the annular gap 3b around the central nozzle 3a. Accurate fixing to each other is here achieved by centering webs 3c.

Thus, component A exits in the center, while component B is supplied as a ring to the applicator surface 2, in particular by a metering dispenser having pumping valves and cartridges 8, one of which is indicated in FIG. 3 down right. Thus, an initial mixture of the components is only obtained at the applicator surface 2. Component B is piped from its cartridge 8, here indicated down right, via a supply channel 4 to floor 5, here the upper one (thus passing through lower floor 6 comprising component A), in order to leave then at the respective annular gap 3b (cf. dash-dotted line). On the other hand, component A is conveyed from pipe union 7, here on the left, to floor 8, in order to be discharged from the respective central nozzle 3a.

The cross-sectional area of nozzle 3a is preferentially circular, but may also be oval or rectangular. In correspondence therewith, annular gap 3b will be formed, e.g. in an oval shape. The nozzles 3a are preferentially of a conical form in order to increase mutual alignment with the centering webs 3c and also be better formed out during injection moulding. However, a cylindrical design of the nozzles 3a is also possible, which here are all in communication with the level or floor 6 for component A. There, floor 6 and the structural members (in particular nozzle 3a) passing component A are kept separate from those structural members passing component B. As indicated in FIG. 3 by three little arrows, it is not before being discharged from annular gap 3b that the components A and B meet to result in the desired mixture A+B only at the applicator surface 2.

1. An applicator for two or more components, in particular for an adjustable metering dispenser, having an applicator surface provided with outlet apertures for the components, wherein
the outlet apertures for the one component (A) and the other component (B) are kept separate from each other up to the applicator surface and are brought together to a point at the applicator surface.

2. An applicator according to claim 1, wherein the outlet apertures are arranged in a pattern.

3. An applicator according to claim 1, wherein the outlet apertures are formed as central nozzles for the one component (A), with one embracing annular gap each for the other component (B).

4. An applicator according to claim 3, wherein centering webs are provided in the annular gap.

5. An applicator according to claim 3, wherein the central nozzles are formed to be conical.

6. An applicator according to claim 1, wherein the one component (A) is provided in a floor which is penetrated by a supply channel for the other component (B) up to a second floor, said floors each communicating independently with different outlet apertures.
